(19) United States
(12) Patent Application Publication
(10) Pub. No.: US 2003/0115332 A1
(43) Pub. Date: Jun. 19, 2003

(54) Communication of information

(76) Inventor: Bernhard Honeisen, Bettwiesen (CH)

Correspondence Address: HARRINGTON & SMITH, LLP, 4 RESEARCH DRIVE, SHELTON, CT, 06484-6212, US

(21) Appl. No.: 10/153,239

(22) Filed: May 21, 2002

(30) Foreign Application Priority Data
May 23, 2001 (FI) 20011089

(51) Int. Cl. G06F 15/16

(52) U.S. Cl. 709/227

(57) ABSTRACT

The invention relates to method for communicating information from a first mobile communication device (UE1) to a second mobile communication device (UE2) via a network. In the method, a SIP (Session Initiation Protocol) INVITE message (31) having a header portion (32) and an SDP (Session Description Protocol) body (33) is sent from the first mobile communication device (UE1) to the second mobile communication device (UE2) via the network. In the SDP body (33), it is indicated a set of codec related features that the first mobile communication device (UE1) supports for a session between the first mobile communication device (UE1) and the second mobile communication device (UE2). The codec related features are a set of codecs that the first mobile communication device (UE1) supports and different options of a particular codec, such as operational modes of an adaptive multi-rate (AMR) codec. In the header portion (32), it is indicated by the network whether the codec related features contained in the set of codec related features are supported by the network.

### FIELD OF THE INVENTION

The invention relates to communicating information. The invention relates especially, but not exclusively, to communicating codec related information between a first communication device and a second communication device via a network.

### BACKGROUND OF THE INVENTION

In wireless telecommunication systems information is transferred in an encoded form between a transmitting communication device and a receiving communication device. The transmitting communication device encodes original information into encoded information and sends it to the receiving communication device. The receiving communication device decodes the received encoded information in order to recreate the original information. The encoding and decoding is performed in codecs. Thus, the encoding is performed in a codec located in the transmitting communication device, and the decoding is performed in a codec located in the receiving communication device. However, since there are many different codecs available, the transmitting terminal and the receiving terminal have to agree upon the codec(s) to be used in a session. This agreeing procedure occurs during the initial session establishment and is called a codec negotiation procedure.

The codec negotiation procedure for third generation (3G) telecommunication systems is currently being standardised. One of the standard proposals for a codec negotiation procedure for third generation telecommunication systems is discussed in the following with the aid of FIGS. 1 and 2.

FIG. 1 shows a third generation telecommunication system for providing codec negotiation. In the system there is formed a signalling chain between a first communication device (hereinafter referred as UE1, UE standing for User Equipment) and a second communication device (hereinafter referred as UE2). The signalling chain goes through a first Proxy Call State Control Function (hereinafter referred as P-CSCF1), a first Serving Call State Control Function (hereinafter referred as S-CSCF1), a second Serving Call State Control Function (hereinafter referred as P-CSCF2), a second Proxy Call State Control Function (hereinafter referred as S-CSCF2). P-CSCF1, S-CSCF1, P-CSCF2 and S-CSCF2 are logical network entities that may be implemented so as to form separate physical network elements, or they may be incorporated in some of the already existing physical network elements. P-CSCF1 and S-CSCF1, for example, may be incorporated in a first GGSN (Gateway General Packet Radio Service (GPRS) Support Node), and they may be controlled by a first network operator. P-CSCF2 and S-CSCF2 may be incorporated in a second GGSN, and they may be controlled by a second network operator. Interfaces between the different devices and functions mentioned above are defined in 3GPP (3^{rd} Generation Partnership Project) specifications. It is known to a person skilled in the art that network elements and/or control functions other than the ones shown in FIG. 1 may reside in the system.

The P-CSCF1 and S-CSCF1 are, among other things, responsible for providing services and reserving resources (for example radio resources) for the UE1. The P-CSCF1 controls the UE1 so that it does not exceed the resources that the network is able to provide for it. The S-CSCF1 controls the UE1 so that it does not exceed the resources to which its user has subscribed.

The P-CSCF2 and S-CSCF2 are, among other things, responsible for providing services and reserving resources for the UE2. The P-CSCF2 controls the UE2 so that it does not exceed the resources that the network is able to provide for it. The S-CSCF2 controls the UE2 so that it does not exceed the resources to which its user has subscribed.

When the UE1 initiates a session with the UE2, the codec to be used for the session is to be determined (negotiated). If the session is going to be a multimedia session that is the session is going to be established with more than one media stream (for example an audio stream and a video stream) codecs to be used with each of the streams are to be negotiated.

According to the standard proposal (3G TS 23.228 version 1.7.0) the negotiation is performed in such a way that the UE1 (also referred to as the session originator) first generates, according to the SIP (Session Initiation Protocol) protocol, a SIP INVITE message comprising particular SIP header fields and a message body. According to the proposal, the message body is generated according to the SDP (Session Description Protocol) protocol and it is called an SDP body.

The UE1 generates the SDP body in such a way that it contains a list (set) of codecs that the UE1 is able and willing to support for the session. The UE1 sends the SIP INVITE message to the UE2. When the SIP INVITE message arrives at the UE2, the UE2 responds to the UE1 by generating and sending a reply message, also containing an SDP body, to the UE1. The reply message is referred to in the SIP protocol as the “183 message”. The SDP body of the reply message contains a second list of codecs indicating the codecs that the UE2 is able and willing to support for the session. The second list is generated based on the content of the list of codecs in the SDP body of the SIP INVITE message and based on the UE2's ability and willingness to support these codecs. If the UE2 is able and willing to support all the same codecs as the UE1 this results in the second list of codecs being the same as the (original) list of codecs that the UE1 generated in the first place. However, if the UE2 is not able or willing to support, for the session, one or more of the codecs contained in the original list, the UE2 leaves such a codec or such codecs out from the second list. This being the case the second list is a sub-list of the original list. In either case, the second list contains the codecs that both the UE1 and the UE2 are able and willing to support for the session.

When the 183 message, sent by the UE2, arrives at the UE1, the UE1 decides which codec (or codecs if it is a multimedia session) of all of the supported codecs contained in the second list is (or are) to be used in the session. After it has decided this it sends to the UE2 a third message (referred to as the Final SDP) which tells to the UE2 the codec(s) that is (or are) to be used in the session to be established.

However, if the messages are sent in an end-to-end manner as described above a problem arises, because the decision of the codec(s) to be used is made without determining from the network the capacity that it is able to provide. For example, the chosen codec might be such a codec that requires a larger bandwidth than the network is able to provide at the time in question.

One standard proposal tries to solve this problem by allowing the network entities P-CSCF1, S-CSCF1, S-CSCF2 and P-CSCF2 to remove non-suitable codecs from the codec list in the SDP of the SIP INVITE message. In the following the matter is described in more detail referring now to FIG. 2.

After the UE1 has determined the codecs that it supports for the session it sends the SIP INVITE message to the UE2. When the SIP INVITE arrives at the P-CSCF1, on its way to the UE2, the P-CSCF1 removes all non-suitable codec choices from the codec list in the SDP body. By a non-suitable codec choice is meant such a codec in the codec list that is, at the moment (or in general based on a network operator policy), not possible for the session from the network's point of view, the network being the one serving the UE1. One example of a non-suitable codec choice would be a codec that uses too large a bandwidth compared to the bandwidth available in the network.

The P-CSCF1 forwards the message to the S-CSCF1 which removes from the codec list all codecs that the UE1 is not authorised to request (based on user subscription information relating to the user of the UE1).

The S-CSCF1 forwards the message to the S-CSCF2 which removes from the codec list all codecs that the UE2 is not authorised to use (based on user subscription information relating to the user of the UE2).

Also, the S-CSCF1 and S-CSCF2 remove from the codec list all codecs that are not supported based on a network operator policy.

The S-CSCF2 forwards the message to the P-CSCF2 which removes all non-suitable codec choices from the codec list in the SDP body. Again, by a non-suitable codec choice is meant such a codec in the codec list that is, at the moment (or in general based on a network operator policy), not possible for the session from the network's point of view, the network now being the one serving the UE2.

Finally, the P-CSCF2 forwards the SIP INVITE message to the UE2. The UE2 receives the SIP INVITE message containing the SDP body which now comprises a list of codecs which both the UE1 and all the logical network entities P-CSCF1, S-CSCF1, S-CSCF2 and P-CSCF2 are willing to support for the session.

The UE2 now responds with a reply message (that is the 183 message) containing a second list of codecs. The second list is generated based on the content of the list of codecs in the SDP body received in the SIP INVITE message and based on the UE2's ability and willingness to support these codecs. If the UE2 is able and willing to support all the codecs contained in the list of codecs, received in the SIP INVITE message, the second list results is same as the list of codecs, received in the SIP INVITE message. If the UE2 is not able or willing to support, for the session, all the codecs contained in the list of codecs, received in the SIP INVITE message, the UE2 leaves such a codec or such codecs out from the second list. In either case, the second list is a list of codecs that both the UE1 and the UE2 and all the network entities P-CSCF1, S-CSCF1, S-CSCF2 and P-CSCF2 are willing to support for the session.

When the 183 message arrives at the UE1 it can make a choice which automatically takes into account the network capabilities, when deciding the codec(s) to be used initially in the session. Information on the chosen codec is sent to the UE2 in a Final SDP message, in a manner similar to that previously described.

In the method described in the foregoing, the network elements are allowed to modify the SDP body of the SIP INVITE message. However, this may affect any message integrity check which is carried out. More particularly, if a check sum is calculated based on the SDP body at the UE1 and another check sum is calculated based on the received SDP body at the UE2 a problem can occur if the message integrity is checked by comparing the check sums. Namely, if the network entities modify the SDP body in between, the check sums do not correspond to each other and the UE2 rejects the message since it assumes that it is corrupted. Another problem occurs if all codecs in the list of codecs are removed by the network. If the SIP INVITE message arrives at the UE2 having no codecs in the codec list the UE2 gets confused.

### SUMMARY OF THE INVENTION

According to a first aspect of the invention there is provided a method for communicating information from a first communication device to a second communication device via a network, the method comprising:

sending from the first communication device a message, via the network, to the second communication device the message comprising a header portion and a message body;

indicating, in the message body, a set of codec related features that the first communication device supports for a session between the first communication device and the second communication device, the method further comprising:

indicating in the header portion of the message, concerning at least one of the codec related features whether that feature is supported by the network.

The term session is to be construed broadly. The term session shall cover various sessions and connection services in which codecs are to be used.

Preferably, it is indicated, in the message body, a set of codecs that the first communication device supports for the session, and indicated, in the header portion, from the set of codecs the codecs that the network does not support for the session.

Preferably, it is indicated, in the message body, a set of options of a particular codec that the first communication device supports for the session, and indicated, in the header portion, from the set of codec options of the particular codec the options that the network does not support for the session.

According to one preferable embodiment, the at least one codec related feature which the network does not support is indicated with the aid of a SIP (Session Initiation Protocol) Warning header field.

According to another preferable embodiment, the at least one codec related feature which the network does not support is indicated with the aid of a header field modifiable by the network.

According to another preferable embodiment, the method comprises: indicating, in the header portion of the message, concerning at least one of the codec related features whether that feature is supported by the network with the aid of a mask having a plurality of mask elements each mask element being representative of one codec related feature.

In this embodiment, each of the plurality of the mask elements indicates whether the corresponding codec related feature is supported wherein:

the mask element taking a first value indicates that the codec related feature is supported; and

the mask element taking a second value indicates that the codec related feature is unsupported.

Preferably, the message body is an SDP (Session Description Protocol) body of a SIP INVITE message, and the header portion comprises one or more SIP header fields for indicating, by the network, concerning at least one of the codec related features whether that feature is supported by the network.

Preferably, the set of codec related features comprises a set of operational modes/bit rates of an AMR (Adaptive Multi Rate) codec.

According to a second aspect of the invention there is provided a transmitting communication device for communicating information to a receiving communication device via a network, the transmitting communication device comprising:

a transmitter for sending a message, via the network, to the receiving communication device the message comprising a header portion and a message body, the transmitting communication device being configured:

to indicate, in the message body, a set of codec related features that the transmitting communication device supports for a session between the transmitting communication device and the receiving communication device, the transmitting communication device being configured:

to send the message in a format which enables the network to indicate, in the header portion of the message, concerning at least one of the codec related features whether that feature is supported by the network.

Preferably, the transmitting communication device and the receiving communication device are mobile communication devices.

According to a third aspect of the invention there is provided a system comprising a first communication device, a network and a second communication device for communicating information from the first communication device to the second communication device via the network, the first communication device comprising:

a transmitter for sending a message from the first communication device, via the network, to the second communication device the message comprising a header portion and a message body, the first communication device being configured:

to indicate, in the message body, a set of codec related features that the first communication device supports for a session between the first communication device and the second communication device, the network comprising:

a processing unit for indicating in the header portion of the message, concerning at least one of the codec related features whether that feature is supported by the network.

According to a forth aspect of the invention there is provided a message for communicating information from a first communication device to a second communication device via a network, the message being configured:

to be sent from the first communication device, via the network, to the second communication device the message comprising:

a message body for indicating a set of codec related features that the first communication device supports for a session between the first communication device and the second communication device, the message further comprising:

a header portion for indicating concerning at least one of the codec related features whether that feature is supported by the network.

According to a fifth aspect of the invention there is provided a computer program product for implementing a network entity the computer program product comprising:

computer executable code for enabling the network entity to handle a message being transferred from a first communication device to a second communication device the message comprising a message body for indicating a set of codec related features that the first communication device supports for a session between the first communication device and the second communication device and a header portion; and

computer executable code for indicating in the header portion of the message, concerning at least one of the codec related features whether that feature is supported by the network entity.

It is to be understood that the codec related features that are supported may be indicated indirectly. This can be done, for example, in a system (and constituent parts thereof) which uses codecs from a fixed, predetermined, set of codecs. In this way, if codec related features that are not supported are indicated, then the supported codec related features should immediately be apparent. This can be applied to the message body, the header portion or both.

### BRIEF DESCRIPTION OF THE DRAWINGS

Embodiments of the invention will now be described by way of example only with reference to the accompanying drawings in which:

FIG. 1 shows a third generation telecommunication system for providing codec negotiation;

FIG. 2 shows a method for codec negotiation in the system presented in FIG. 1;

FIG. 3 shows a message structure suitable for codec negotiation;

FIGS. 4a to 4c show particular details of a message according to the embodiments of the invention;

FIG. 5 shows a cellular mobile station suitable for the implementing the invention; and

FIG. 6 shows a GGSN suitable for the implementing the invention.

### DETAILED DESCRIPTION

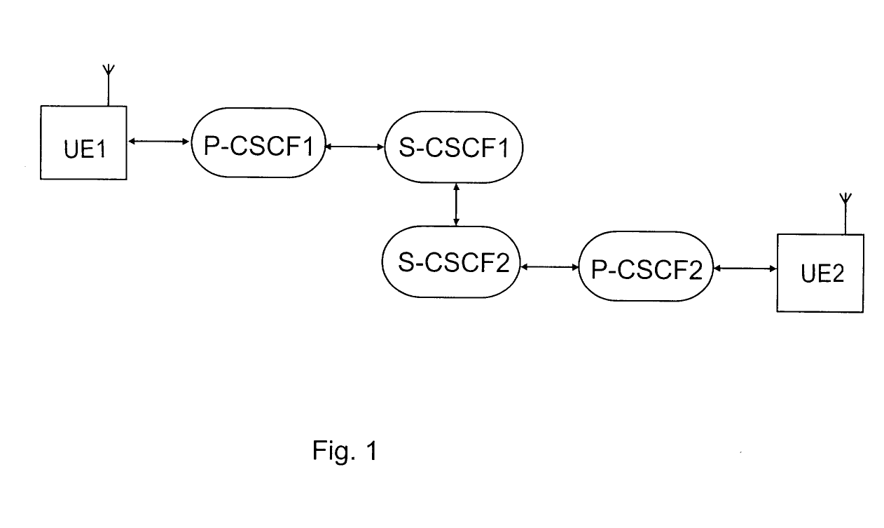

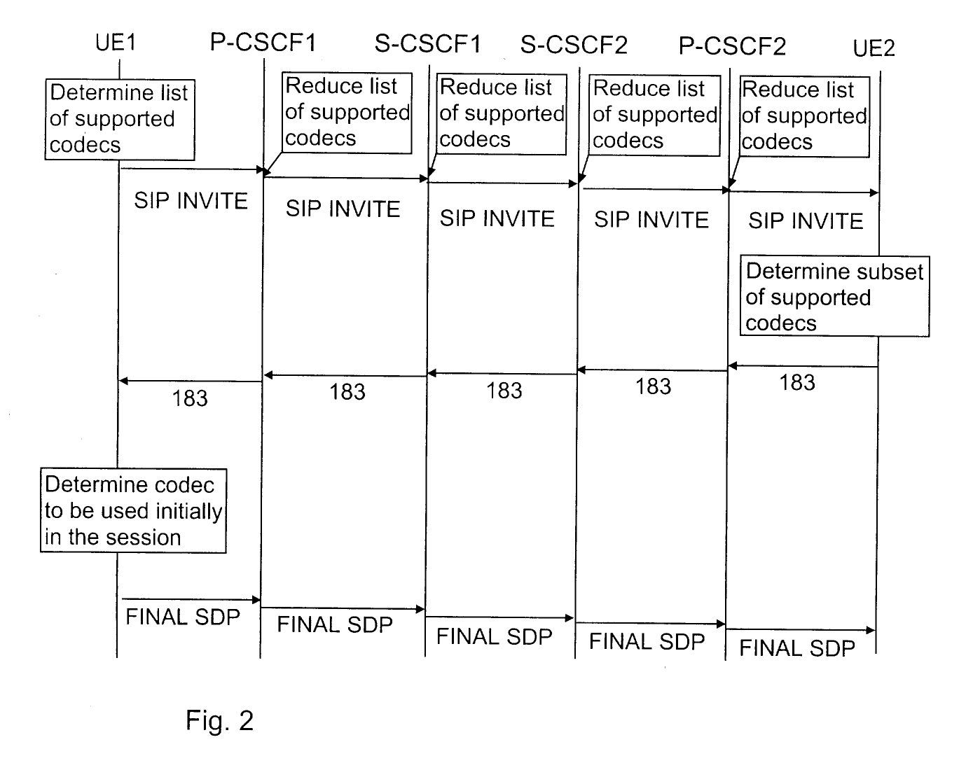

The system and message sequence shown in FIGS. 1 and 2 can also be used in a preferred embodiment of the invention. Accordingly, in the preferred embodiment of the invention, a first communication device UE1 first sends to a second communication device UE2 a SIP INVITE message in response to which the UE2 responds with a reply message (for example with a “183 message”). When the UE1 receives the reply message it decides on the codec(s) to be used in a session to be established. The UE1 generates, based on the decision, a third message (Final SDP) and sends the third message containing the information about the decided/chosen codec(s) to the UE2.

In the preferred embodiment the UE1 is a wireless mobile station of a cellular radio network and the UE2 is another wireless mobile station of the same or another cellular radio network. An example of the cellular radio network is a wideband code division multiple access (WCDMA) network or another third generation network.

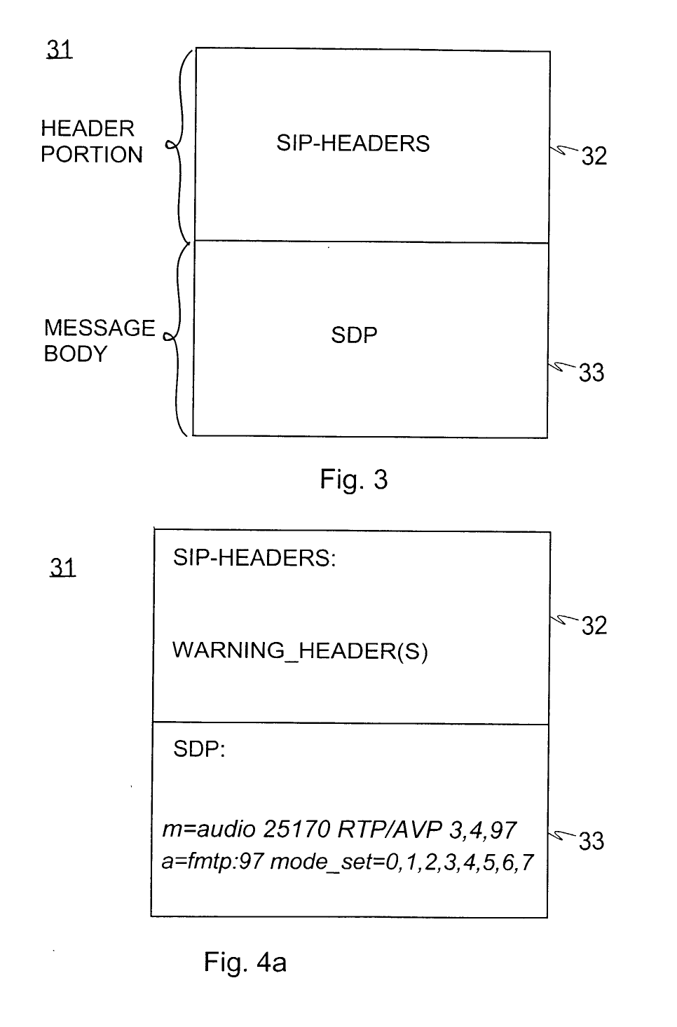

FIG. 3 shows the basic SIP message structure. This is the basic structure of all the three messages sent in the preferred embodiment. A SIP message 31 comprises SIP header fields 32 and a message body that is an SDP body 33.

The SIP header fields 32 contain information about the sender and the recipient of the message such as address information and other general information familiar to a person skilled in the art.

The SDP body 33 contains information concerning those media streams (for example information on ports and codecs) to be used in a session. Each media stream is defined in the SDP with the aid of one media line that is an m-line. Each media stream may be even more specifically defined with the aid of one or more attribute lines that is one or more a-lines following the m-line.

Let us now assume that the UE1 wants to initiate an audio (speech) session with the UE2. In this exemplary case the UE1 supports the following three codecs for the audio session: the GSM (Global System for Mobile communications) codec, the G.723 codec and the AMR codec. The m-line for this media (in the SDP of the SIP INVITE message) would then be like this:

m=audio 25170 RTP/AVP 3, 4, 97,

wherein audio indicates the media type that is audio stream, 25170 indicates the port number at which the UE1 wants to receive the media, RTP/AVP (Real-Time Transport Protocol/Audio Video Protocol) is the transport protocol to be used and the numbers 3, 4 and 97 indicate the codecs, defined in RTP/AVP, that the UE1 is able and willing to support for the session. The mappings according to RTP/AVP are such that number 3 indicates the GSM codec, number 4 indicates the G.723 codec and number 97 indicates the AMR codec.

Since the AMR codec has eight different modes of operation so that it can operate with eight different bit rates, these AMR modes/bit rates should also be indicated.

According to the preferred embodiment of the invention the rates that the UE1 supports for the session are indicated with the aid of an a-line in the SDP body.

The AMR codec itself supports all eight bit rates, but the UE1 might not be able or willing to support all of the bit rates. For example, if UE1 is performing another task simultaneously with the session to be established it may be that the UE1 is not willing to support some of the highest bit rates at the initial stage of the session, although it might, in general, be able to support these bit rates. However, a typical situation is that the UE1 is both able and willing to support all the bit rates.

In this exemplary case the UE1 supports all the eight bit rates. Thus, the a-line (in the SDP of the SIP INVITE message) would look like this:

a=fmtp:97 mode_set=0, 1, 2, 3, 4, 5, 6, 7,

wherein fmtp basically indicates the message body format, 97 indicates that the a-line is for the AMR codec, mode_set=0, 1, 2, 3, 4, 5, 6, 7 indicates the AMR modes/rates that the UE1 supports for the session. The meaning of numbers 0 to 7 in the mode_set and the use of the binary mask will be explained in greater detail in the following.

In the mode_set-list the numbers 0 to 7 correspond the different AMR codec modes/rates in the following way:

| | | |
|---|---|---|
| 0 | [symbol] | 12.2 kbps |
| 1 | [symbol] | 10.2 kbps |
| 2 | [symbol] | 7.95 kbps |
| 3 | [symbol] | 7.40 kbps |
| 4 | [symbol] | 6.70 kbps |
| 5 | [symbol] | 5.90 kbps |
| 6 | [symbol] | 5.15 kbps |
| 7 | [symbol] | 4.75 kbps |

If a particular mode number is included in the a-line the corresponding mode/rate is supported by the UE1. Thus, since all the numbers 0 to 7 appear in the list this is to be construed such that the UE1 supports all eight modes/bit rates.

The UE1 wirelessly sends the SIP INVITE message containing the SDP body comprising the above described m-line and a-line to the UE2. Contrary to the prior art, if the network entities P-CSCF1, S-CSCF1, S-CSCF2 or P-CSCF2 discover any non-suitable codec choices in the SDP body they do not modify the SDP body, that is they do not remove any non-suitable codec choices from the list in the m-line. Instead, they indicate in the message header (fields) portion 32 of the message if one or more codec choices are non-suitable.

Similarly, relating to the AMR codec modes/bit rates, the network entities indicate in the message header (fields) portion 32 if one or more AMR rates that the UE1 indicates as being supported is not supported by them.

In the following, three alternatives are shown for indicating, by the network, the unsupported codec choices/options. By the term “codec options” is meant different options that a particular/single codec may have, such as different AMR codec bit rates, whereas the term “codec choices” refers to the codecs itself.

One alternative for indicating, by the network, the unsupported codec choices/options is the use of SIP Warning headers, another is the use of a new modifiable header field specifically indicating unsupported codec choices/options and yet another alternative is the use of so-called binary mask.

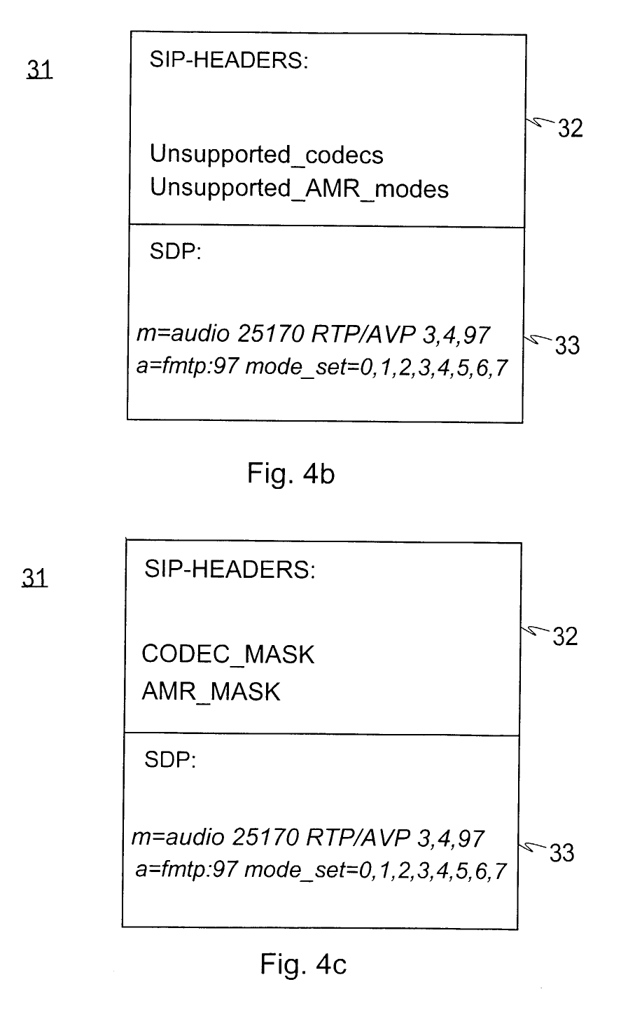

Of these alternatives the use of Warning headers is described first. The Warning header, as such, is known to a person skilled in the art. In this alternative, when the SIP INVITE message, on its way to the UE2, passes through a network entity that network entity checks from the SDP body in the m-line the supported codecs and if the network entity (or more specifically the network) does not support one or more of the supported codecs it adds a SIP Warning header field to the header portion of the SIP INVITE message (FIG. 4a). The SIP Warning header indicates (to the UE2) that the particular one or more codec(s) is/are not supported by the_network. FIG. 4a also shows the contents of the m-line and the a-line of the SDP body in this exemplary case.

A similar method may be applied to the different codec options of a particular/single codec, for example the AMR codec modes/bit rates. Thus, in this embodiment, when the SIP INVITE message, on its way to the UE2, passes through a network entity that network entity checks from the SDP body in the a-line the supported AMR bit rates and if the network entity does not support one or more of these bit rates it adds a SIP Warning header field (FIG. 4a) to the SIP header portion of the SIP INVITE message that indicates that the particular bit rate(s) is/are not supported by the network.

The second alternative, the use of a new modifiable header field specifically indicating unsupported codec choices/options, is described in the following. In this alternative, when the SIP INVITE message, on its way to the_UE2, passes through a network entity the network entity checks from the SDP body in the m-line the supported codecs. If the network entity does not support one or more of the supported codecs it adds a new header field to the header portion of the SIP INVITE message the new header field indicating that the particular codec(s) is/are not supported by the network. The new header field can be named for example as “Unsupported codecs” (as shown in FIG. 4b) and the content of that field indicates the unsupported codecs from the network's point of view. Every network entity discovering unsupported codecs does not have to insert a new “Unsupported_codecs” header field but it can add to an already existing “Unsupported codecs” field (if there is one), which some other network entity (or the UE1) has added to the SIP INVITE message. It can for example be the case that the first network entity that does not support one or more of the codec choices indicated as being supported adds the header field.

A similar method may be applied to the different codec options of a particular/single codec, for example the AMR codec modes/bit rates. Thus, in this embodiment, when the SIP INVITE message, on its way to the UE2, passes through a network entity the network entity checks from the SDP body in the a-line the supported AMR bit rates and, if the network entity does not support one or more of these bit rates, it adds a new header field to the header portion of the SIP INVITE message the new header field indicating that the particular AMR bit rate(s) is/are not supported by the network. The new header_field can be named for example as “Unsupported_AMR_modes” (FIG. 4b) and the content of that field indicates the unsupported AMR bit rates from the network's point of view. Again, if there already exists an “Unsupported_AMR_modes” header field the network entity can add to an already existing header field rather than inserting a new one.

The third alternative, the use of a binary mask, is described in the following. According to this alternative when the SIP INVITE message is being generated by the UE1, the UE1 inserts one or more binary masks into the header portion of the SIP INVITE message. There may be different masks: one mask for different codecs and one or more masks for different options of the codecs. In FIG. 4c is illustrated two masks, the first one (CODEC_MASK) is for the network to indicate the supported/unsupported codecs and the second one (AMR_MASK) is for the network to indicate the supported/unsupported AMR codec modes/bit rates.

In the following, the use of the second mask, the AMR_MASK is described in detail. The AMR_MASK is a header field containing a binary number having as many digits as there are AMR bit rates. The binary digits are in such an order that each binary digit corresponds to one AMR bit rate. Each binary digit 1 corresponds to a supported AMR bit rate and each binary digit 0 corresponds to an unsupported AMR bit rate. However, in order to consume less space in the SIP messages the AMR_MASK may be expressed as a decimal number in the header field. It is to be noted that depending on the implementation, either the decimal number presentation or the binary number presentation of the AMR_MASK is actually transmitted in the SIP messages.

In this exemplary case, the UE1 is both able and willing to support all eight AMR bit rates (as described already in the foregoing) due to which the AMR_MASK takes the initial value 11111111 which corresponds to the decimal number 255. The correspondence between binary digits and AMR codec modes/bit rates is as follows:

$$\begin{matrix}255 = 11111111 \\ \vert \vert \vert \vert \vert \vert \vert \vert \\ 01234567 ( AMR modes \text{/} bit rates ) .\end{matrix}$$

Thus, the AMR_MASK indicates that all the eight AMR modes/bit rates 0 to 7 are supported by the UE1, because in the AMR_MASK there is a binary digit 1 corresponding to each of the modes/bit rates.

Now, when the SIP INVITE message, on its way to the UE2, passes through a network entity the network entity checks from the SDP body in the a-line the (by the UE1) supported AMR bit rates and if the network entity does not support one or more of the AMR modes/bit rates that the a-line indicates as being supported it modifies the AMR_MASK accordingly. For example, if the P-CSCF1 does not support rates 12.2 kbps (AMR mode 0), 7.40 kbps (AMR mode 3) and 5.90 kbps (AMR mode 5) it changes in the AMR_MASK the binary digits corresponding to the unsupported AMR bit rates from value 1 to value 0. The modification of the AMR_MASK is illustrated in the following:

$$\begin{matrix}\begin{matrix}255 = \underline{1} 11 \underline{1} 1 \underline{1} 11 \\ ↓ ↓ ↓\end{matrix} \\ \begin{matrix}107 = 01101011 \\ \vert \vert \vert \vert \vert \vert \vert \vert \\ 01234567 ( AMR modes \text{/} bit rates ) .\end{matrix}\end{matrix}$$

This results in the AMR_MASK being modified by the P-CSCF1 from decimal number 255 to decimal number 107 in the header field.

If the next network entity through which the SIP INVITE message passes, in turn does not support AMR bit rates 12.2 kbps (AMR mode 0) and 7.95 kbps (AMR mode 2) it changes in the AMR_MASK the binary digit corresponding to the unsupported AMR bit rate 7.95 kbps (AMR mode 2) from value 1 to value 0. The S-CSCF1 does not have to do anything in relation to the unsupported bit rate 12.2 kbps (AMR mode 0) because the binary digit corresponding to that mode/bit rate already has the value 0. The modification of the AMR_MASK is illustrated in the following:

$$\begin{matrix}\begin{matrix}107 = 01 \underline{1} 01011 \\ ↓\end{matrix} \\ \begin{matrix}75 = 01001011 \\ \vert \vert \vert \vert \vert \vert \vert \vert \\ 01234567 ( AMR modes \text{/} bit rates ) .\end{matrix}\end{matrix}$$

This results the mask being modified by the network entity from decimal number 107 to decimal number 75 in the header field.

Before the SIP INVITE message arrives at the UE2, also the other network entities through which the SIP INVITE messages passes modify the AMR_MASK in the header field if they do not support one or more of the AMR modes/bit rates that the a-line in the SDP body (and the AMR_MASK) indicates as being supported.

The CODEC_MASK may be used in a corresponding way.

The SIP INVITE message finally arrives at the UE2. Regardless of which one of the presented alternatives has been used by the network to indicate the unsupported codec choices/options, the SDP body in the SIP INVITE message tells to the UE2 the codecs and the codec options that the UE1 is able and willing to support for the session. However, information on codecs and codec options that are supported/unsupported by the network is found in the header fields portion of the SIP INVITE message.

Again, the reply message is a SIP message containing SIP header fields and an SDP body. The reply message is generated based on the content of the received SIP INVITE message and based on the UE2's ability and willingness to support codecs and AMR modes (and other possible codec options). The reply message also comprises an m-line and an a-line the contents of which are generated based on the properties of the UE2 and based on the content of the m-line and a-line of the received SIP INVITE message. In this exemplary case the port where the UE2 wants to receive the media (that is audio) stream is the port number 26250. The codecs that the UE2 supports for the session are: the GSM codec (number 3) and the AMR codec (number 97). Thus, the m-line of the SDP body of the reply message initially looks like this:

m=audio 26250 RTP/AVP 3, 97,

wherein 26250 indicates the port number at which the UE2 wants to receive the media, RTP/AVP (Real-Time Transport Protocol/Audio Video Protocol) is the transport protocol to be used and the numbers 3 (the GSM codec) and 97 (the AMR codec) indicate the codecs, defined in RTP/AVP, that the UE2 is able and willing to support for the session.

The AMR codec of the UE2 supports by definition all the AMR modes/bit rates, and, in this case, the device UE2 itself also supports all AMR modes/bit rates. This is a typical case. Thus, the content of the a-line of the reply message is the same as the a-line in the SDP of the SIP INVITE message as received at the UE2, that is:

a=fmtp:97 mode_set=0, 1, 2, 3, 4, 5, 6, 7,

wherein fmtp basically indicates the message body format, 97 indicates that the a-line is for the AMR codec and mode_set=0, 1, 2, 3, 4, 5, 6, 7 indicates the AMR modes/bit rates that the UE2 supports for the session. If the UE2 would not have supported all the modes the numbers corresponding to the unsupported modes would have been omitted from the mode_set-list.

In addition, the UE2 copies the header fields that indicate the network capabilities (supported/unsupported codecs and codec options) from the header portion of the SIP INVITE message to the header portion of the reply message. In addition or alternatively, the UE2 may take the network capabilities into account already when generating the m-line and the a-line of the SDP of the reply message and omit the codecs choices and/or the codec options that the network does not support from the m-line and/or the a-line accordingly.

The UE2 sends the reply message to the UE1. Although there should be no need for the network entities to modify the header fields of the reply message further (relating to the supported codecs and/or codec options), it may be possible for the network entities to make such a modification if the situation in the network has changed.

When the UE1 receives the reply message the SDP body of the reply message tells to the UE1 the codecs and the codec options that the UE2 is able and willing to support for the session. However, information on codecs and codec options that are supported/unsupported by the network is found in the header fields portion of the reply message.

Taking into consideration both the capabilities of the communication devices UE1 and UE2 and the capabilities of the network the UE1 now decides the codec and the codec option (if any) to be used initially in the (audio) session. For example, the UE1 may decide that the AMR codec is to be used initially in the session. From the codec options, the UE1 may decide that the AMR codec bit rate 10.2 kbps (mode 1) is to be used initially.

Now, the UE1 generates the third message (Final SDP or a corresponding message). Again, this is a SIP message containing SIP header fields and an SDP body. The UE1 includes in the SDP body information on which codec is to be used initially in the session. If the chosen codec is the AMR codec, as it is in this case, the UE1 also includes in the SDP body information on which AMR bit rate is to be used initially. Also, other information relating to codecs may be conveyed in the third message, for example additional information about other bit rates and other codecs that may be used. Thus, if the codec and/or bit rate has to be changed during the established session the possible choices would already be known to the UE1 and the UE2.

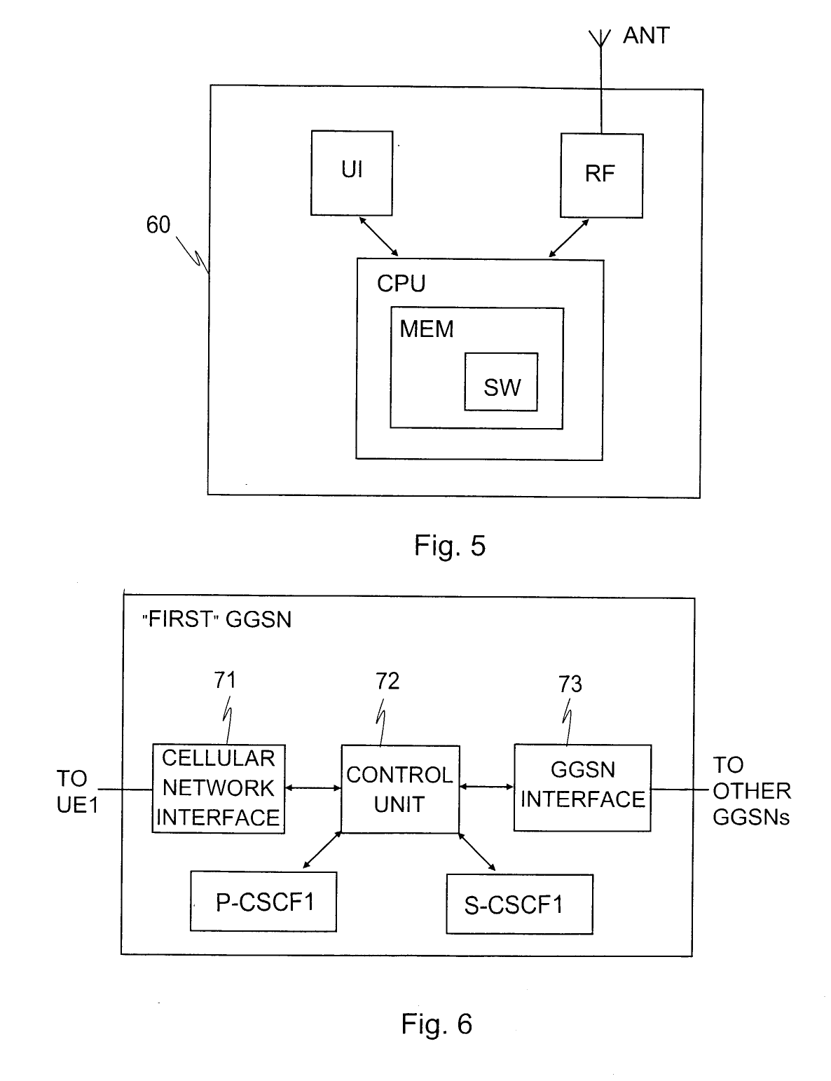

The invention may be implemented by software. In FIG. 5 is shown a cellular mobile station 60 suitable for implementing the invention. The mobile station 60 shown operates as the UE1. A corresponding mobile station may operate as the UE2. The mobile station 60 comprises a processing unit CPU, a radio frequency part RF and a user interface UI. The radio frequency part RF and the user interface UI are coupled to the processing unit CPU. The user interface UI comprises a display and a keyboard (not shown) to enable a user to use the mobile station 60. In addition, the user interface UI comprises a microphone and a speaker for receiving and producing audio signals. The processing unit CPU comprises a microprocessor (not shown), memory MEM and software SW. The software SW is stored in the memory MEM. The microprocessor controls, on the basis of the software SW, the operation of the mobile station 60, such as the use of the radio frequency part RF and the presenting of information in the user interface UI and the reading of inputs received from the user interface UI. The software SW comprises a WCDMA protocol stack on the basis of which a transmitter (not shown) of the radio frequency part RF transmits and a receiver (not shown) of the radio frequency part RF receives messages and other information with the aid of its antenna ANT. The codecs the support of which is negotiated reside in the mobile station 60. They may be implemented in the software SW. Another alternative is hardware implementation of the codecs (not shown).

FIG. 6 shows a GGSN suitable for implementing the invention. The GGSN shown serves the UE1 and a corresponding one serves the UE2. The GGSNs may be controlled by different network operators. The GGSN comprises a cellular network interface 71, a control unit 72 and a GGSN interface 73. The cellular network interface 71 and the GGSN interface 73 are coupled to the control unit 72. The GGSN sends and receives information to and from the UE1 via the cellular network interface 71. Typically, there are several other network elements between the GGSN and the UE1. These network elements such as a base station, a base station controller and a SGSN (Serving GPRS Support Node) are well known by a person skilled in the art. The GGSN sends and receives information to and from the GGSN serving the UE2 via the GGSN interface 73. The latter GGSN then has a corresponding cellular network interface for communicating information with the UE2.

The network entities P-CSCF1, S-CSCF1, S-CSCF2 and P-CSCF2 are logical network entities implemented by software. The network entities may be implemented so as to form separate physical network elements, or they may be incorporated in some of the already existing physical network elements. In this embodiment, the network entities P-CSCF1 and S-CSCF1 are incorporated in a first GGSN a nd coupled with the control unit of that GGSN, and the network entities S-CSCF2 and P-CSCF2 are incorporated in a second GGSN and coupled with the control unit of that GGSN. Alternatively, the logical network entities can be located in another computer, but are linked with the GGSN.

The control unit 72 comprises a processor or another processing unit, memory and software comprising a program code. The software is stored in the memory. The processor controls, on the basis of the software, the operation of the GGSN, such as the use of the the cellular network interface 71 and the GGSN interface 73. The processor of the first GGSN implements the functionality of the logical network entities P-CSCF1 and S-CSCF1, and the processor of the second GGSN implements the functionality of the logical network entities S-CSCF2 and P-CSCF2.

As to the method according to the invention, the microprocessor of the mobile station UE1 (FIG. 5) generates the SIP INVITE message, by using the software SW. It forwards the SIP INVITE message to the radio frequency part RF which transmits the SIP INVITE message wirelessly to the base station of a cellular network from which the message is conveyed to the first GGSN (serving the UE1). The first GGSN receives the SIP INVITE message via the cellular network interface 71. The processor of the control unit 72 implements the adding/modification of the header field(s) according to the logical network entity P-CSCF1. Thereafter the processor of the control unit 72 implements the adding/modification of the header field(s) according to the logical network entity S-CSCF1. Here it is to be understood that although the preferred embodiment of the invention talks about forwarding the SIP INVITE message from the P-CSCF1 to the S-CSCF1 the forwarding of the message may occur, instead of a physical forwarding, by another type of forwarding where the message content just is transferred from one software process to another in one and the same device/computer.

The control unit 72 uses the GGSN interface 73 in forwarding the SIP INVITE message to the second GGSN (the one serving the UE2). The second GGSN receives the SIP INVITE message via the GGSN interface 73. The processor of the control unit 72 implements the adding/modification of the header field(s) according to the logical network entity S-CSCF2. Thereafter the processor of the control unit 72 implements the adding/modification of the header field(s) according to the logical network entity P-CSCF2. Thereafter the second GGSN forwards the SIP INVITE message to the UE2 via the cellular network interface 71.

The radio frequency part RF of the UE2 receives the SIP INVITE message via its antenna ANT (FIG. 5) and forwards the SIP INVITE message to the processing unit CPU. The microprocessor of the processing unit CPU handles the SIP INVITE message and generates the reply message. It handles the copying of the necessary header fields from the SIP INVITE message to the reply message, as well, and sends the reply message via the two GGSNs to the UE1. The microprocessor of the UE1 decides the codec(s) and the codec option(s) to be used initially in the session. It generates the third message and transmits it to the UE2 via the two GGSNs. In relation to the second alternative for the network indicating the unsupported codec choices/options, instead of indicating the unsupported codecs, a network entity through which the SIP INVITE message passes may indicate the supported codec choices/options. The header fields that the network entity modifies or inserts in the header portion of the SIP INVITE message may be named as “Supported_codecs” or “Supported_AMR_modes” instead of the previously mentioned “Unsupported_codecs” or “Unsupported_AMR_modes” header fields.

Yet another embodiment of the invention relates to a situation in which one of the communication devices UE1, UE2 does not operate as it should. For example, if the UE2 does not copy the header fields containing information about the network capabilities from the SIP INVITE message to the reply message, the UE1 does not get the needed information about the network capabilities and thus, decides the codec to be used in the session without taking into consideration the network capabilities. This is an error situation which should be prevented. This embodiment of the invention tries to prevent the error situation by allowing the P-CSCF2 (or other policy enforcement function) to store the content of the SIP INVITE message header field(s) containing the network capability information to a memory. When the reply message, on its way to the UE1, passes through the P-CSCF2 the P-CSCF2 checks if the header field(s) containing the network capability information has/have been correctly copied to the header portion of the reply message. If the header field(s) has/have not been copied correctly, the P-CSCF2 replaces the incorrectly copied header field(s) by the stored one(s) (or if the header field(s) has/have not been copied at all, the P-CSCF2, instead of replacing, inserts the stored header field(s) to the reply message).

According to a yet another embodiment of the invention the header fields of the SIP INVITE message are used to indicate QoS (Quality of Service) limitations. For example, there may be a header field “Max_Bandwidth” which the network entities may modify. “Max_Bandwidth” refers to a maximum bandwidth that a network entity allows (or is able to provide). The first network entity that has a bandwidth limitation adds the “Max_Bandwidth” header field and sets as the value of the header field a value corresponding to the bandwidth that the network entity allows (or is able to provide). Other network entities through which the message travels replace the value of the “Max_Bandwidth” header field with their own values of allowed bandwidth if the value is bigger than each network entity allows (or is able to provide). The same principle may be applied for other QoS parametres, too.

According to a yet another embodiment of the invention, when the UE1 generates the SIP INVITE message it inserts, in addition of the (first) SDP body previously described, another substantially identical SDP body (containing a similar m-line and a-line like the other SDP body contains) into the SIP INVITE message. This second SDP body is modifiable for the network. According to this embodiment, when the SIP INVITE message travels through a network entity the network entity checks the content of the m-line(s) and the a-line(s) of the first SDP body. If the network entity does not support one or more of the codec choices/options indicated in the m-line(s) or the a-line(s) of the first SDP body the network entity modifies the m-line(s) or the a-line(s) of the second SDP body in order to indicate the unsupported codec choices/options. The m-line(s) and the a-line(s) of the first SDP body and the header portion of the message are left untouched. Thus, if the message integrity check is performed only based on the first SDP, but not based on the second SDP, the message integrity check may be performed without the previously described problems.

According to the invention, it is possible to provide for the communication devices UE1 and UE2 information about network capabilities. It is possible to define which of the suggested codecs and codec options are supported and which are not supported by the network. It is, for example, possible to tell to the communication devices UE1 and UE2 which AMR modes/source bit rates are supported by the network. When using the SIP message header portion to indicate the supported/unsupported codecs/codec options it is possible to mitigate the problem relating to message integrity checking, because now the SDP body of the SIP INVITE message does not have to be modified by the logical network entities P-CSCF1, S-CSCF1, S-CSCF2 and P-CSCF2 and thus, the UE2 does not assume that the message is corrupted and does not reject the message.

In addition to the codec negotiation procedure presented in the preceding description the basic message structure and the use of the header fields is also applicable in other codec negotiation procedures where the message sequence may deviate from the one presented. The invention is not restricted to the particular names of the messages (SIP INVITE, 183 message and FINAL SDP). The use of the header fields may be implemented in a plurality of different ways without deviating from the invention. If the binary mask is used, the UE1 does not necessarily have to insert the binary mask to the header portion of the SIP INVITE message, but the mask may be inserted by the first network entity that does not support one or more of the codecs and/or codec options. The same applies to the use of the second SDP body.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method for communicating information from a first communication device to a second communication device via a network, the method comprising:
sending from the first communication device a message, via the network, to the second communication device the message comprising a header portion and a message body;
indicating, in the message body, a set of codec related features that the first communication device supports for a session between the first communication device and the second communication device, wherein the method further comprises:
indicating in the header portion of the message, concerning at least one of the codec related features whether that feature is supported by the network.

2. A method according to claim 1, wherein the method comprises:
indicating, in the message body, a set of codecs that the first communication device supports for the session, and indicating, in the header portion, from the set of codecs the codecs that the network does not support for the session.

3. A method according to claim 1 or claim 2, wherein the method comprises: indicating, in the message body, a set of options of a particular codec that the first communication device supports for the session, and indicating, in the header portion, from the set of codec options of the particular codec the options that the network does not support for the session.

4. A method according to any of the preceding claims, wherein the method comprises:
indicating the at least one codec related feature which the network does not support with the aid of a SIP (Session Initiation Protocol) Warning header field.

5. A method according to any of the preceding claims, wherein the method comprises:
indicating the at least one codec related feature which the network does not support, with the aid of a header field modifiable by the network.

6. A method according to any of the preceding claims, wherein the method comprises:
indicating, in the header portion of the message, concerning at least one of the codec related features whether that feature is supported by the network with the aid of a mask having a plurality of mask elements each mask element being representative of one codec related feature.

7. A method according to claim 6, wherein each of the plurality of the mask elements indicates whether the corresponding codec related feature is supported wherein:
the mask element taking a first value indicates that the codec related feature is supported; and
the mask element taking a second value indicates that the codec related feature is unsupported.

8. A method according to any of the preceding claims, wherein the message body is an SDP (Session Description Protocol) body of a SIP INVITE message, and the header portion comprises one or more SIP header fields for indicating, by the network, concerning at least one of the codec related features whether that feature is supported by the network.

9. A method according to any of the preceding claims, wherein at least one of the communication devices is a mobile communication device.

10. A method according to any of the preceding claims, wherein the set of codec related features comprises a set of operational modes/bit rates of an AMR (Adaptive Multi Rate) codec.

11. A transmitting communication device for communicating information to a receiving communication device via a network, the transmitting communication device comprising:
a transmitter for sending a message, via the network, to the receiving communication device the message comprising a header portion and a message body, the transmitting communication device being configured:
to indicate, in the message body, a set of codec related features that the transmitting communication device supports for a session between the transmitting communication device and the receiving communication device, wherein the transmitting communication device is configured:
to send the message in a format which enables the network to indicate, in the header portion of the message, concerning at least one of the codec related features whether that feature is supported by the network.

12. A transmitting communication device according to claim 11, wherein it is a mobile communication device.

13. A system comprising a first communication device, a network and a second communication device for communicating information from the first communication device to the second communication device via the network, the first communication device comprising:
a transmitter for sending a message from the first communication device, via the network, to the second communication device the message comprising a header portion and a message body, the first communication device being configured:
to indicate, in the message body, a set of codec related features that the first communication device supports for a session between the first communication device and the second communication device, wherein the network comprises:
a processing unit for indicating in the header portion of the message, concerning at least one of the codec related features whether that feature is supported by the network.

14. A system according to claim 13, wherein at least one of the first and the second communication devices is a mobile communication device.

15. A message for communicating information from a first communication device to a second communication device via a network, the message being configured:
to be sent from the first communication device, via the network, to the second communication device the message comprising:
a message body for indicating a set of codec related features that the first communication device supports for a session between the first communication device and the second communication device, wherein the message further comprises:
a header portion for indicating concerning at least one of the codec related features whether that feature is supported by the network.

16. A computer program product for implementing a network entity the computer program product comprising:
computer executable code for enabling the network entity to handle a message being transferred from a first communication device to a second communication device the message comprising a message body for indicating a set of codec related features that the first communication device supports for a session between the first communication device and the second communication device and a header portion; and
computer executable code for indicating in the header portion of the message, concerning at least one of the codec related features whether that feature is supported by the network entity.
